(19) United States
(12) Patent Application Publication
(10) Pub. No.: US 2023/0367823 A1
(43) Pub. Date: Nov. 16, 2023

(54) APPARATUS, METHOD, AND COMPUTER PROGRAM

(71) Applicant: NOKIA SOLUTIONS AND NETWORKS OY, Espoo (FI)

(72) Inventors: Ioannis MOUROULIS, Athens (GR); Devaki CHANDRAMOULI, Plano, TX (US); Ulrich WIEHE, Bad Hersfeld (DE)

(73) Assignee: NOKIA SOLUTIONS AND NETWORKS OY, Espoo (FI)

(21) Appl. No.: 18/247,036

(22) PCT Filed: Sep. 29, 2020
(86) PCT No.: PCT/US20/53271

§ 371 Date: Mar. 28, 2023

(51) Int. Cl. G06F 16/908; G06F 16/21; G06F 16/901

(52) U.S. Cl. CPC G06F 16/908; G06F 16/212; G06F 16/901

(57) ABSTRACT

The disclosure relates to an apparatus comprising means for: storing a metadata schema, wherein the metadata schema comprises at least one tag type with at least one attribute defining how a metadata tag is to be stored in a record and/or at least one attribute defining how a metadata tag stored in a record is to be used; and storing a metadata tag in a record and/or using a metadata tag stored in a record based on the at least one attribute.

### FIELD OF THE DISCLOSURE

The present disclosure relates to an apparatus, a method, and a computer program for storing metadata in a record and/or using metadata stored in the record.

### BACKGROUND

A communication system can be seen as a facility that enables communication sessions between two or more entities such as user terminals, base stations/access points and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet. In a wireless communication system at least a part of a communication session between at least two stations occurs over a wireless link.

A user can access the communication system by means of an appropriate communication device or terminal. A communication device of a user is often referred to as user equipment (UE) or user device. A communication device is provided with an appropriate signal receiving and transmitting apparatus for enabling communications, for example enabling access to a communication network or communications directly with other users. The communication device may access a carrier provided by a station or access point and transmit and/or receive communications on the carrier.

The communication system and associated devices typically operate in accordance with a required standard or specification which sets out what the various entities associated with the system are permitted to do and how that should be achieved. Communication protocols and/or parameters which shall be used for the connection are also typically defined. One example of a communications system is UTRAN (3G radio). Another example of an architecture that is known as the long-term evolution (LTE) or the Universal Mobile Telecommunications System (UMTS) radio-access technology. Another example communication system is so called 5G radio or new radio (NR) access technology.

### SUMMARY

According to an aspect there is provided an apparatus comprising means for: storing a metadata schema, wherein the metadata schema comprises at least one tag type with at least one attribute defining how a metadata tag is to be stored in a record and/or at least one attribute defining how a metadata tag stored in a record is to be used; and storing a metadata tag in a record and/or using a metadata tag stored in a record based on the at least one attribute.

The at least one attribute defining how a metadata tag is to be stored in a record may comprise a tag name.

The at least one attribute defining how a metadata tag is to be stored in a record may comprise a format of a tag value.

The at least one attribute defining how a metadata tag is to be stored in a record may comprise an indication of whether a presence of the metadata tag is optional or mandatory.

The at least one attribute defining how a metadata tag is to be stored in a record may comprise an indication of a default tag value when the presence of the metadata tag is optional.

The at least one attribute defining how a metadata tag stored in a record is to be used may comprise a key type.

The key type may be one of: a first key type defining that the metadata tag can be used to search for the record and the search results in at most one matching record; a second key type defining that the metadata tag can be used to search for the record and the search results in one or more matching records; a third key type defining that the metadata tag can be used to search for the record and the search results in a sum of one or more matching records; a fourth key type defining that the metadata tag can be used to search for the record and the search results in one or more matching records and defining that the metadata tag can be used to search for the record and the search results in a sum of one or more matching records; a fifth key type defining that the metadata tag correspond to a timer, can be used to search for the record and the search results in one or more matching records; a sixth key type defining that the metadata tag correspond to a timer and cannot be used to search for the record; and a seventh key type defining that the metadata tag cannot be used to search for the record.

The metadata tag may correspond to a timer, comprises a timer name, a timer value and a uniform resource identifier where a network function receives a notification when the timer value expires.

The metadata schema may comprise a metadata schema identifier.

The apparatus may comprise means for: receiving the metadata schema identifier with the metadata schema from a network function; and storing the metadata schema identifier with the metadata schema.

The apparatus may comprise means for: receiving a metadata tag with the metadata schema identifier from a network function; determining that the metadata tag abides by the at least one attribute of the at least one tag type of the metadata schema; and storing the metadata tag.

The apparatus may comprise means for: receiving a search query with the metadata schema identifier from a network function; and using the metadata schema identifier to search for a record.

The apparatus may be an unstructured data storage function.

According to an aspect there is provided an apparatus comprising at least one processor and at least one memory including computer code for one or more programs, the at least one memory and the computer code configured, with the at least one processor, to cause the apparatus at least to: store a metadata schema, wherein the metadata schema comprises at least one tag type with at least one attribute defining how a metadata tag is to be stored in a record and/or at least one attribute defining how a metadata tag stored in a record is to be used; and store a metadata tag in a record and/or using a metadata tag stored in a record based on the at least one attribute.

The at least one attribute defining how a metadata tag is to be stored in a record may comprise a tag name.

The at least one attribute defining how a metadata tag is to be stored in a record may comprise a format of a tag value.

The at least one attribute defining how a metadata tag is to be stored in a record may comprise an indication of whether a presence of the metadata tag is optional or mandatory.

The at least one attribute defining how a metadata tag is to be stored in a record may comprise an indication of a default tag value when the presence of the metadata tag is optional.

The at least one attribute defining how a metadata tag stored in a record is to be used may comprise a key type.

The key type may be one of: a first key type defining that the metadata tag can be used to search for the record and the search results in at most one matching record; a second key type defining that the metadata tag can be used to search for the record and the search results in one or more matching records; a third key type defining that the metadata tag can be used to search for the record and the search results in a sum of one or more matching records; a fourth key type defining that the metadata tag can be used to search for the record and the search results in one or more matching records and defining that the metadata tag can be used to search for the record and the search results in a sum of one or more matching records; a fifth key type defining that the metadata tag correspond to a timer, can be used to search for the record and the search results in one or more matching records; a sixth key type defining that the metadata tag correspond to a timer and cannot be used to search for the record; and a seventh key type defining that the metadata tag cannot be used to search for the record.

The metadata tag may correspond to a timer, comprises a timer name, a timer value and a uniform resource identifier where a network function receives a notification when the timer value expires.

The metadata schema may comprise a metadata schema identifier.

The at least one memory and the computer code may be configured, with the at least one processor, to cause the apparatus at least to: receive the metadata schema identifier with the metadata schema from a network function; and store the metadata schema identifier with the metadata schema.

The at least one memory and the computer code may be configured, with the at least one processor, to cause the apparatus at least to: receive a metadata tag with the metadata schema identifier from a network function; determine that the metadata tag abides by the at least one attribute of the at least one tag type of the metadata schema; and storing the metadata tag.

The at least one memory and the computer code may be configured, with the at least one processor, to cause the apparatus at least to: receive a search query with the metadata schema identifier from a network function; and use the metadata schema identifier to search for a record.

The apparatus may be an unstructured data storage function.

According to an aspect there is provided an apparatus comprising circuitry configured to: store a metadata schema, wherein the metadata schema comprises at least one tag type with at least one attribute defining how a metadata tag is to be stored in a record and/or at least one attribute defining how a metadata tag stored in a record is to be used; and store a metadata tag in a record and/or using a metadata tag stored in a record based on the at least one attribute.

The at least one attribute defining how a metadata tag is to be stored in a record may comprise a tag name.

The at least one attribute defining how a metadata tag is to be stored in a record may comprise a format of a tag value.

The at least one attribute defining how a metadata tag is to be stored in a record may comprise an indication of whether a presence of the metadata tag is optional or mandatory.

The at least one attribute defining how a metadata tag is to be stored in a record may comprise an indication of a default tag value when the presence of the metadata tag is optional.

The at least one attribute defining how a metadata tag stored in a record is to be used may comprise a key type.

The key type may be one of: a first key type defining that the metadata tag can be used to search for the record and the search results in at most one matching record; a second key type defining that the metadata tag can be used to search for the record and the search results in one or more matching records; a third key type defining that the metadata tag can be used to search for the record and the search results in a sum of one or more matching records; a fourth key type defining that the metadata tag can be used to search for the record and the search results in one or more matching records and defining that the metadata tag can be used to search for the record and the search results in a sum of one or more matching records; a fifth key type defining that the metadata tag correspond to a timer, can be used to search for the record and the search results in one or more matching records; a sixth key type defining that the metadata tag correspond to a timer and cannot be used to search for the record; and a seventh key type defining that the metadata tag cannot be used to search for the record.

The metadata tag may correspond to a timer, comprises a timer name, a timer value and a uniform resource identifier where a network function receives a notification when the timer value expires.

The metadata schema may comprise a metadata schema identifier.

The apparatus may comprise circuitry configured to: receive the metadata schema identifier with the metadata schema from a network function; and store the metadata schema identifier with the metadata schema.

The apparatus may comprise circuitry configured to: receive a metadata tag with the metadata schema identifier from a network function; determine that the metadata tag abides by the at least one attribute of the at least one tag type of the metadata schema; and storing the metadata tag.

The apparatus may comprise circuitry configured to: receive a search query with the metadata schema identifier from a network function; and use the metadata schema identifier to search for a record.

The apparatus may be an unstructured data storage function.

According to an aspect there is provided a method comprising: storing a metadata schema, wherein the metadata schema comprises at least one tag type with at least one attribute defining how a metadata tag is to be stored in a record and/or at least one attribute defining how a metadata tag stored in a record is to be used; and storing a metadata tag in a record and/or using a metadata tag stored in a record based on the at least one attribute.

The at least one attribute defining how a metadata tag is to be stored in a record may comprise a tag name.

The at least one attribute defining how a metadata tag is to be stored in a record may comprise a format of a tag value.

The at least one attribute defining how a metadata tag is to be stored in a record may comprise an indication of whether a presence of the metadata tag is optional or mandatory.

The at least one attribute defining how a metadata tag is to be stored in a record may comprise an indication of a default tag value when the presence of the metadata tag is optional.

The at least one attribute defining how a metadata tag stored in a record is to be used may comprise a key type.

The key type may be one of: a first key type defining that the metadata tag can be used to search for the record and the search results in at most one matching record; a second key type defining that the metadata tag can be used to search for the record and the search results in one or more matching records; a third key type defining that the metadata tag can be used to search for the record and the search results in a sum of one or more matching records; a fourth key type defining that the metadata tag can be used to search for the record and the search results in one or more matching records and defining that the metadata tag can be used to search for the record and the search results in a sum of one or more matching records; a fifth key type defining that the metadata tag correspond to a timer, can be used to search for the record and the search results in one or more matching records; a sixth key type defining that the metadata tag correspond to a timer and cannot be used to search for the record; and a seventh key type defining that the metadata tag cannot be used to search for the record.

The metadata tag may correspond to a timer, comprises a timer name, a timer value and a uniform resource identifier where a network function receives a notification when the timer value expires.

The metadata schema may comprise a metadata schema identifier.

The method may comprise: receiving the metadata schema identifier with the metadata schema from a network function; and storing the metadata schema identifier with the metadata schema.

The method may comprise: receiving a metadata tag with the metadata schema identifier from a network function; determining that the metadata tag abides by the at least one attribute of the at least one tag type of the metadata schema; and storing the metadata tag.

The method may comprise: receiving a search query with the metadata schema identifier from a network function; and using the metadata schema identifier to search for a record.

The method may be performed by an unstructured data storage function.

According to an aspect there is provided a computer program comprising computer executable code which when run on at least one processor is configured to: store a metadata schema, wherein the metadata schema comprises at least one tag type with at least one attribute defining how a metadata tag is to be stored in a record and/or at least one attribute defining how a metadata tag stored in a record is to be used; and store a metadata tag in a record and/or using a metadata tag stored in a record based on the at least one attribute.

The at least one attribute defining how a metadata tag is to be stored in a record may comprise a tag name.

The at least one attribute defining how a metadata tag is to be stored in a record may comprise a format of a tag value.

The at least one attribute defining how a metadata tag is to be stored in a record may comprise an indication of whether a presence of the metadata tag is optional or mandatory.

The at least one attribute defining how a metadata tag is to be stored in a record may comprise an indication of a default tag value when the presence of the metadata tag is optional.

The at least one attribute defining how a metadata tag stored in a record is to be used may comprise a key type.

The key type may be one of: a first key type defining that the metadata tag can be used to search for the record and the search results in at most one matching record; a second key type defining that the metadata tag can be used to search for the record and the search results in one or more matching records; a third key type defining that the metadata tag can be used to search for the record and the search results in a sum of one or more matching records; a fourth key type defining that the metadata tag can be used to search for the record and the search results in one or more matching records and defining that the metadata tag can be used to search for the record and the search results in a sum of one or more matching records; a fifth key type defining that the metadata tag correspond to a timer, can be used to search for the record and the search results in one or more matching records; a sixth key type defining that the metadata tag correspond to a timer and cannot be used to search for the record; and a seventh key type defining that the metadata tag cannot be used to search for the record.

The metadata tag may correspond to a timer, comprises a timer name, a timer value and a uniform resource identifier where a network function receives a notification when the timer value expires.

The metadata schema may comprise a metadata schema identifier.

The computer program may comprise computer executable code which when run on at least one processor is configured to: receive the metadata schema identifier with the metadata schema from a network function; and store the metadata schema identifier with the metadata schema.

The computer program may comprise computer executable code which when run on at least one processor is configured to: receive a metadata tag with the metadata schema identifier from a network function; determine that the metadata tag abides by the at least one attribute of the at least one tag type of the metadata schema; and storing the metadata tag.

The computer program may comprise computer executable code which when run on at least one processor is configured to: receive a search query with the metadata schema identifier from a network function; and use the metadata schema identifier to search for a record.

The at least one processor may be part of an unstructured data storage function.

According to an aspect there is provided an apparatus comprising means for: providing a metadata schema, wherein the metadata schema comprises at least one tag type with at least one attribute defining how a metadata tag is to be stored in a record and/or at least one attribute defining how a metadata tag stored in a record is to be used.

The at least one attribute defining how a metadata tag is to be stored in a record may comprise a tag name.

The at least one attribute defining how a metadata tag is to be stored in a record may comprise a format of a tag value.

The at least one attribute defining how a metadata tag is to be stored in a record may comprise an indication of whether a presence of the metadata tag is optional or mandatory.

The at least one attribute defining how a metadata tag is to be stored in a record may comprise a default tag value when the presence of the metadata tag is optional.

The at least one attribute defining how a metadata tag stored in a record is to be used may comprise at least one key type.

The key type may be one of: a first key type defining that the metadata tag can be used to search for the record and the search results in at most one matching record; a second key type defining that the metadata tag can be used to search for the record and the search results in one or more matching records; a third key type defining that the metadata tag can be used to search for the record and the search results in a sum of one or more matching records; a fourth key type defining that the metadata tag can be used to search for the record and the search results in one or more matching records and defining that the metadata tag can be used to search for the record and the search results in a sum of one or more matching records; a fifth key type defining that the metadata tag correspond to a timer, can be used to search for the record and the search results in one or more matching records; a sixth key type defining that the metadata tag correspond to a timer and cannot be used to search for the record; and a seventh key type defining that the metadata tag cannot be used to search for the record.

The metadata tag may correspond to a timer, may comprise a timer name, a timer value and a uniform resource identifier; and the apparatus may comprise means for receiving a notification when the timer value expires via the uniform resource identifier.

The metadata schema may comprise a metadata schema identifier.

The apparatus may comprise means for: providing the metadata schema identifier with the metadata schema to an unstructured data storage function.

The apparatus may comprise means for: providing the metadata with the metadata schema identifier to an unstructured data storage function.

The apparatus may comprise means for: providing a search query with a metadata schema identifier to an unstructured data storage function.

The apparatus may be a network function

According to an aspect there is provided an apparatus comprising at least one processor and at least one memory including computer code for one or more programs, the at least one memory and the computer code configured, with the at least one processor, to cause the apparatus at least to: provide a metadata schema, wherein the metadata schema comprises at least one tag type with at least one attribute defining how a metadata tag is to be stored in a record and/or at least one attribute defining how a metadata tag stored in a record is to be used.

The at least one attribute defining how a metadata tag is to be stored in a record may comprise a tag name.

The at least one attribute defining how a metadata tag is to be stored in a record may comprise a format of a tag value.

The at least one attribute defining how a metadata tag is to be stored in a record may comprise an indication of whether a presence of the metadata tag is optional or mandatory.

The at least one attribute defining how a metadata tag is to be stored in a record may comprise a default tag value when the presence of the metadata tag is optional.

The at least one attribute defining how a metadata tag stored in a record is to be used may comprise at least one key type.

The key type may be one of: a first key type defining that the metadata tag can be used to search for the record and the search results in at most one matching record; a second key type defining that the metadata tag can be used to search for the record and the search results in one or more matching records; a third key type defining that the metadata tag can be used to search for the record and the search results in a sum of one or more matching records; a fourth key type defining that the metadata tag can be used to search for the record and the search results in one or more matching records and defining that the metadata tag can be used to search for the record and the search results in a sum of one or more matching records; a fifth key type defining that the metadata tag correspond to a timer, can be used to search for the record and the search results in one or more matching records; a sixth key type defining that the metadata tag correspond to a timer and cannot be used to search for the record; and a seventh key type defining that the metadata tag cannot be used to search for the record.

The metadata tag may correspond to a timer, may comprise a timer name, a timer value and a uniform resource identifier; and the apparatus may comprise means for receiving a notification when the timer value expires via the uniform resource identifier.

The metadata schema may comprise a metadata schema identifier.

The at least one memory and the computer code may be configured, with the at least one processor, to cause the apparatus at least to: provide the metadata schema identifier with the metadata schema to an unstructured data storage function.

The at least one memory and the computer code may be configured, with the at least one processor, to cause the apparatus at least to: provide the metadata with the metadata schema identifier to an unstructured data storage function.

The at least one memory and the computer code may be configured, with the at least one processor, to cause the apparatus at least to: provide a search query with a metadata schema identifier to an unstructured data storage function.

The apparatus may be a network function.

According to an aspect there is provided an apparatus comprising circuitry configured to: provide a metadata schema, wherein the metadata schema comprises at least one tag type with at least one attribute defining how a metadata tag is to be stored in a record and/or at least one attribute defining how a metadata tag stored in a record is to be used.

The at least one attribute defining how a metadata tag is to be stored in a record may comprise a tag name.

The at least one attribute defining how a metadata tag is to be stored in a record may comprise a format of a tag value.

The at least one attribute defining how a metadata tag is to be stored in a record may comprise an indication of whether a presence of the metadata tag is optional or mandatory.

The at least one attribute defining how a metadata tag is to be stored in a record may comprise a default tag value when the presence of the metadata tag is optional.

The at least one attribute defining how a metadata tag stored in a record is to be used may comprise at least one key type.

The key type may be one of: a first key type defining that the metadata tag can be used to search for the record and the search results in at most one matching record; a second key type defining that the metadata tag can be used to search for the record and the search results in one or more matching records; a third key type defining that the metadata tag can be used to search for the record and the search results in a sum of one or more matching records; a fourth key type defining that the metadata tag can be used to search for the record and the search results in one or more matching records and defining that the metadata tag can be used to search for the record and the search results in a sum of one or more matching records; a fifth key type defining that the metadata tag correspond to a timer, can be used to search for the record and the search results in one or more matching records; a sixth key type defining that the metadata tag correspond to a timer and cannot be used to search for the record; and a seventh key type defining that the metadata tag cannot be used to search for the record.

The metadata tag may correspond to a timer, may comprise a timer name, a timer value and a uniform resource identifier; and the apparatus may comprise means for receiving a notification when the timer value expires via the uniform resource identifier.

The metadata schema may comprise a metadata schema identifier.

The apparatus may comprise circuitry configured to: provide the metadata schema identifier with the metadata schema to an unstructured data storage function.

The apparatus may comprise circuitry configured to: provide the metadata with the metadata schema identifier to an unstructured data storage function.

The apparatus may comprise circuitry configured to: provide a search query with a metadata schema identifier to an unstructured data storage function.

The apparatus may be a network function.

According to an aspect there is provided a method comprising: providing a metadata schema, wherein the metadata schema comprises at least one tag type with at least one attribute defining how a metadata tag is to be stored in a record and/or at least one attribute defining how a metadata tag stored in a record is to be used.

The at least one attribute defining how a metadata tag is to be stored in a record may comprise a tag name.

The at least one attribute defining how a metadata tag is to be stored in a record may comprise a format of a tag value.

The at least one attribute defining how a metadata tag is to be stored in a record may comprise an indication of whether a presence of the metadata tag is optional or mandatory.

The at least one attribute defining how a metadata tag is to be stored in a record may comprise a default tag value when the presence of the metadata tag is optional.

The at least one attribute defining how a metadata tag stored in a record is to be used may comprise at least one key type.

The key type may be one of: a first key type defining that the metadata tag can be used to search for the record and the search results in at most one matching record; a second key type defining that the metadata tag can be used to search for the record and the search results in one or more matching records; a third key type defining that the metadata tag can be used to search for the record and the search results in a sum of one or more matching records; a fourth key type defining that the metadata tag can be used to search for the record and the search results in one or more matching records and defining that the metadata tag can be used to search for the record and the search results in a sum of one or more matching records; a fifth key type defining that the metadata tag correspond to a timer, can be used to search for the record and the search results in one or more matching records; a sixth key type defining that the metadata tag correspond to a timer and cannot be used to search for the record; and a seventh key type defining that the metadata tag cannot be used to search for the record.

The metadata tag may correspond to a timer, may comprise a timer name, a timer value and a uniform resource identifier; and the apparatus may comprise means for receiving a notification when the timer value expires via the uniform resource identifier.

The metadata schema may comprise a metadata schema identifier.

The method may comprise: providing the metadata schema identifier with the metadata schema to an unstructured data storage function.

The method may comprise: providing the metadata with the metadata schema identifier to an unstructured data storage function.

The method may comprise: providing a search query with a metadata schema identifier to an unstructured data storage function.

The method may be performed by a network function.

According to an aspect there is provided a computer program comprising computer executable code which when run on at least one processor is configured to: provide a metadata schema, wherein the metadata schema comprises at least one tag type with at least one attribute defining how a metadata tag is to be stored in a record and/or at least one attribute defining how a metadata tag stored in a record is to be used.

The at least one attribute defining how a metadata tag is to be stored in a record may comprise a tag name.

The at least one attribute defining how a metadata tag is to be stored in a record may comprise a format of a tag value.

The at least one attribute defining how a metadata tag is to be stored in a record may comprise an indication of whether a presence of the metadata tag is optional or mandatory.

The at least one attribute defining how a metadata tag is to be stored in a record may comprise a default tag value when the presence of the metadata tag is optional.

The at least one attribute defining how a metadata tag stored in a record is to be used may comprise at least one key type.

The key type may be one of: a first key type defining that the metadata tag can be used to search for the record and the search results in at most one matching record; a second key type defining that the metadata tag can be used to search for the record and the search results in one or more matching records; a third key type defining that the metadata tag can be used to search for the record and the search results in a sum of one or more matching records; a fourth key type defining that the metadata tag can be used to search for the record and the search results in one or more matching records and defining that the metadata tag can be used to search for the record and the search results in a sum of one or more matching records; a fifth key type defining that the metadata tag correspond to a timer, can be used to search for the record and the search results in one or more matching records; a sixth key type defining that the metadata tag correspond to a timer and cannot be used to search for the record; and a seventh key type defining that the metadata tag cannot be used to search for the record.

The metadata tag may correspond to a timer, may comprise a timer name, a timer value and a uniform resource identifier; and the apparatus may comprise means for receiving a notification when the timer value expires via the uniform resource identifier.

The metadata schema may comprise a metadata schema identifier.

The computer program may comprise computer executable code which when run on at least one processor is configured to: provide the metadata schema identifier with the metadata schema to an unstructured data storage function.

The computer program may comprise computer executable code which when run on at least one processor is configured to: provide the metadata with the metadata schema identifier to an unstructured data storage function.

The computer program may comprise computer executable code which when run on at least one processor is configured to: provide a search query with a metadata schema identifier to an unstructured data storage function.

The at least one processor may be part of a network function.

According to an aspect, there is provided a computer readable medium comprising program instructions stored thereon for performing at least one of the above methods.

According to an aspect, there is provided a non-transitory computer readable medium comprising program instructions stored thereon for performing at least one of the above methods.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

### List of Abbreviations

AF: Application Function
AMF: Access Management Function
API: Application Protocol Interface
BS: Base Station
CNF: Cloud-native/Containarized Network Function
CU: Centralized Unit
DL: Downlink
DU: Distributed Unit
eNB: eNodeB
gNB: gNodeB
GSM: Global System for Mobile communication
GUTI: Global Unique Temporary Identifier
HSS: Home Subscriber Server
IoT: Internet of Things
LTE: Long Term Evolution
MAC: Medium Access Control
MS: Mobile Station
MTC: Machine Type Communication
NEF: Network Exposure Function
NF: Network Function
NGAP: NG Application Protocol
NR: New radio
NRF: Network function Repository Function
OAM: Operation Administration and Maintenance
PDU: Packet Data Unit
RAM: Random Access Memory
(R)AN: (Radio) Access Network
ROM: Read Only Memory
SMF: Session Management Function
S-NSSAI: Single-Network Slice Selection Assistance Information
SUCI: Subscriber Concealed Identifier
SUPI: Subscriber Permanent Identifier
TIMSI: Temporary Mobile Subscriber Identifier
TR: Technical Report
TS: Technical Specification
TTL: Time To Live
UDSF: Unstructured Data Storage Function
UE: User Equipment
UMTS: Universal Mobile Telecommunication System
URI: Uniform Resource Identifier
3GPP: 3^{rd} Generation Partnership Project
5G: 5^{th} Generation
5GC: 5G Core network
5GS: 5G System

### BRIEF DESCRIPTION OF THE FIGURES

Embodiments will now be described, by way of example only, with reference to the accompanying Figures in which:

FIG. 1 shows a schematic representation of a 5G system;

FIG. 2 shows a schematic representation of a control apparatus;

FIG. 3 shows a schematic representation of a terminal;

FIG. 4 shows a schematic representation of the structure of the resource uniform resource identifier of a nudsf-dr application programming interface as per TS29.598 (3GPP Rel-16);

FIG. 5 shows a signalling diagram of a process for searching for records stored in an unstructured data storage function as per TS29.598 (3GPP Rel-16);

FIG. 6 shows a table providing a definition of a type RecordMeta as per TS29.598 (3GPP Rel-16);

FIG. 7a shows a schematic representation of records stored in an unstructured data storage function;

FIG. 7b shows a signalling diagram of a process for searching for records stored in an unstructured data storage function;

FIG. 8 shows a schematic representation of the structure of the resource uniform resource identifier of a nudsf-dr application programming interface as per the disclosure;

FIG. 9 shows a table providing a definition of a type RecordMeta as per the disclosure;

FIG. 10 shows a table providing a list of enumeration of comparison operators as per the disclosure;

FIG. 11 shows a signalling diagram of a process for storing a metadata schema in an unstructured data storage function as per the disclosure;

FIG. 12 shows a table providing a definition of a type MetaSchema as per the disclosure;

FIG. 13 shows a table providing a definition of a type tagType as per the disclosure;

FIG. 14 shows a signalling diagram of a process for storing metadata in an unstructured data storage function as per the disclosure;

FIG. 15 shows a signalling diagram of a process for using metadata in an unstructured data storage function to search for records as per the disclosure;

FIG. 16 shows a signalling diagram of a process for using metadata in an unstructured data storage function to notify an expired timer as per the disclosure;

FIG. 17 shows a block diagram of a method performed by an unstructured data storage function for storing metadata in a record and/or using metadata stored in a record as per the disclosure;

FIG. 18 shows a block diagram of a method performed by a network function for storing metadata in a record and/or using metadata stored in a record as per the disclosure; and

FIG. 19 shows a schematic representation of a non-volatile memory medium storing instructions which when executed by a processor allow a processor to perform one or more of the steps of the methods of FIGS. 17 and 18.

### DETAILED DESCRIPTION OF THE FIGURES

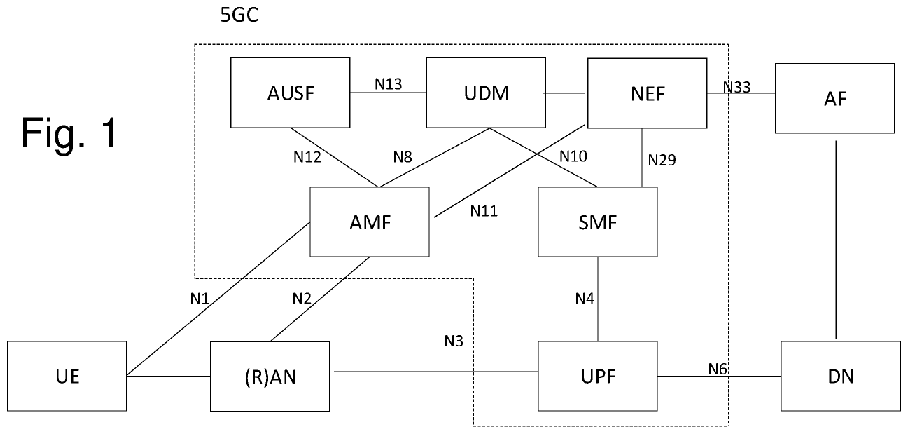

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS). The 5GS may comprises a terminal, a (radio) access network ((R)AN), a 5G core network (5GC), one or more application functions (AF) and one or more data networks (DN).

The 5G (R)AN may comprise one or more gNodeB (gNB) distributed unit functions connected to one or more gNodeB (gNB) centralized unit functions.

The 5G may be used for mobile access or for fixed access. The 5GC may comprise an access management function (AMF), a session management function (SMF), an authentication server function (AUSF), a user data management (UDM), a user plane function (UPF) and/or a network exposure function (NEF). Although not illustrated the 5GC may comprise other network functions (NF), such as an unstructured data storage function (UDSF).

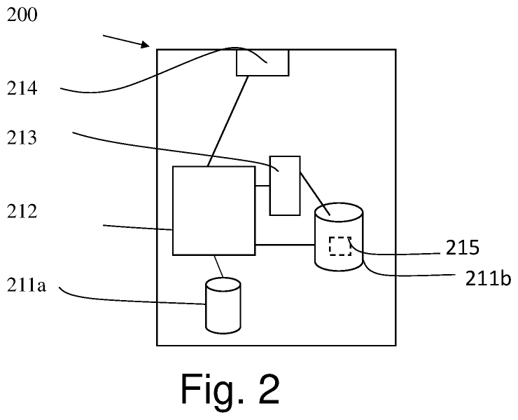

FIG. 2 illustrates an example of a control apparatus 200 for controlling a function of the (R)AN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5G (R)AN or the 5GC. In some embodiments, each function of the (R)AN or the 5GC comprises a control apparatus 200. In alternative embodiments, two or more functions of the (R)AN or the 5GC may share a control apparatus.

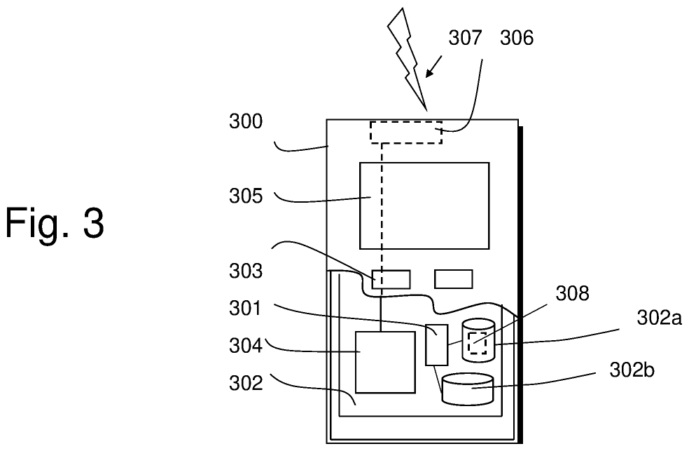

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302a and the ROM 211b. The at least one processor 301 may be configured to execute an appropriate software code 308. The software code 308 may for example allow to perform one or more of the present aspects. The software code 308 may be stored in the ROM 302b.

The processor, storage and other relevant control apparatus can be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

One or more aspect of this disclosure relate to a Nudsf_DataRepository service application programming interface (API). The Nudsf_DataRepository service API is standardized in Rel-16 and defines how UDSF service consumers may store and retrieve unstructured data in a UDSF.

As per TS 29.598 data in a UDSF may be placed in records. Each record may have a record identifier (recordId). Each record may correspond for example to a UE. Each record may comprise none, one or more blocks. For example, a record may comprise a mobility management block, a session management block or other. Each block may comprise a content with arbitrary structure. The content and structure of the block(s) is not known by the UDSF. Additionally, each record may comprise RecordMeta (i.e. record metadata).

Storage and retrieval of records in the UDSF can be very efficient when the recordId is known by the UDSF service consumer. However, in many cases the recordId is not known by the UDSF service consumer (e.g. a Stateless NF having to serve a request) and the NF may have to first perform a search in the UDSF for records based on GET query parameters that are applied as RecordMeta filters (RecordMeta information element (IE). RecordMeta filters are based on tags. A tag may comprise a tag name and one or more tag values with no specific structure which does not facilitate efficient searches.

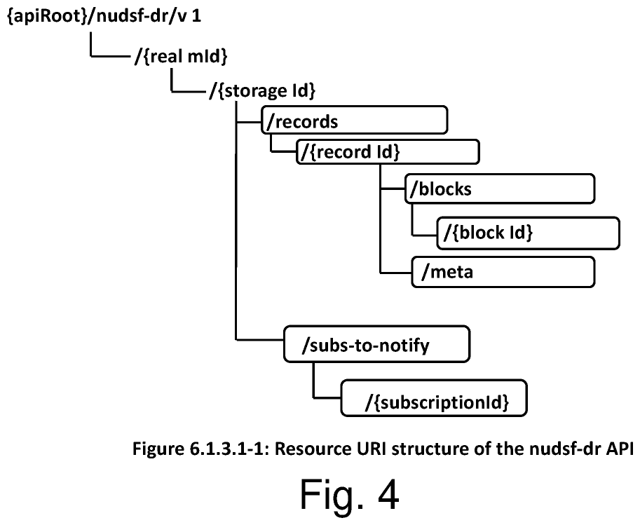

FIG. 4 shows a schematic representation of a resource uniform resource identifier of a nudsf-dr application programming interface as per TS29.598.

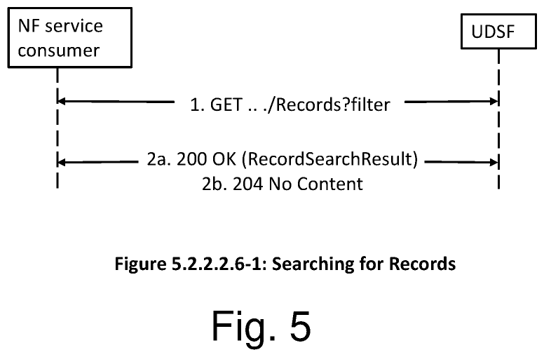

FIG. 5 shows a signalling diagram of a process for searching for records stored in a UDSF as per TS29.598. FIG. 5 shows a scenario where a NF service consumer sends a request to the UDSF to search for a record that matches RecordMeta filters. The request contains RecordMeta filters and optionally supported-features, limit-range, page-number and count-indicator.

In step 1, the NF service consumer (any NF) sends a GET request to a record resource with the RecordMeta filters.

In step 2a, on success, the UDSF responds with “200 OK” with the message body containing the RecordSearchResult.

In step 2b, if the UDSF is not able to return any record for the given RecordMeta filters, the HTTP status code “204 No Content” is returned.

On failure, the appropriate HTTP status code indicating the error may be returned and appropriate additional error information may be returned in the GET response body.

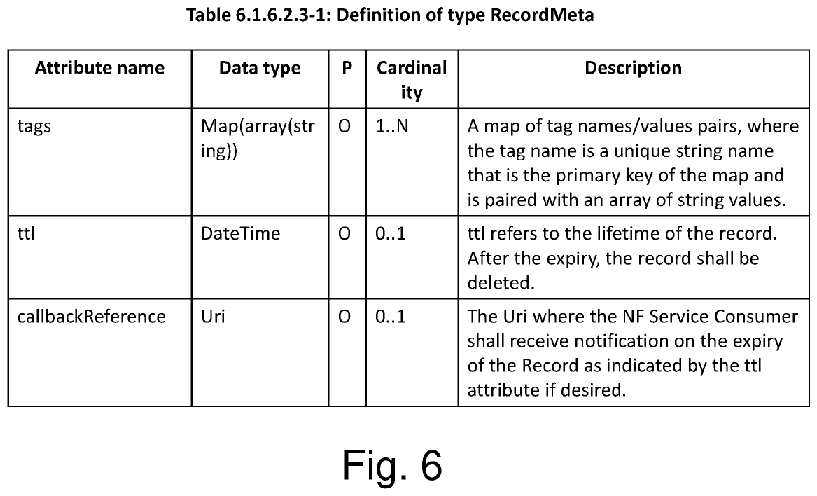

FIG. 6 shows a table providing a definition of a type RecordMeta as per TS29.598.

RecordMeta may comprise tags attributes. Tags is a map between a tag name and one or more tag values. The tag name is a unique string name that is the primary key of the map. The one or more tag values may be an array of string values.

RecordMeta may comprise a time to live (ttl) timer attribute. The ttl refers to the lifetime of the record. After the expiry of the ttl timer the record may be deleted.

RecordMeta may comprise a callbackReference attribute. The callbackReference comprises a URI where the NF Service Consumer may receive notification on the expiry of the ttl timer.

A NF may have three possible levels of statelessness.

A NF may be a stateless NF. UE state information is pulled by the NF from the UDSF for the duration of a transaction only (e.g. PCF).

A NF may be state efficient NF. UE state information may be pulled by the NF from the UDSF and kept there during periods of high UE activity, cached for a few seconds or minutes. The UE state information may be stored by the NF in the UDSF at the end of a certain procedure (e.g. AMF or SMF).

A NF may be a stateful NF. UE state information may be stored permanently in the NF (e.g. UDR).

Stateless NFs or state efficient NFs operating as a set of NFs in case of NF failure may not know the RecordId of the relevant Record where the data required to complete an operation is stored and may have to fetch data stored in UDSF based on various search criterions. The criterion may be based on whatever is available by a request that triggered the operation or the background activity (e.g. subscriber permanent identifier (SUPI), global unique temporary identifier (GSPI), timer expiration, single-network slice selection assistance information (S-NSSAI) or other).

A UDSF realm or storage may contain a very large number of records. Thus, traversing all the records in the whole realm or storage to resolve search requests may require a lot of computing resources.

For example, without indexing a UDSF serving 25 million UEs for a state efficient AMF set may perform 40 thousand searches/sec. Assuming a low value of only 1 Idle/Connected transition every 10 min per UE, the UDSF may perform 1 trillion 5G global unique temporary identifier (5G-GUTI) checks/sec.

Indexes or similar constructs may be used to perform efficient searches based on RecordMeta However, indexes may also make record writes and updates in UDSF more expensive while certain tags in the RecordMeta may anyhow not be planned to be used as search criterions. Certain tags in the RecordMeta be for example intended to be used only to produce aggregate counters.

Moreover, there is currently no solution in the standards for stateless NF service consumers to monitor timers and handle timer expiration in records stored in the UDSF. It is assumed to be solved in a proprietary manner. One possible approach is to store time stamp information in the blocks or RecordMeta of the records stored in the UDSF and perform periodic polling. However, with this approach the timer may have already expired by the time a context is retrieved.

One or more aspects of this disclosure enhance the UDSF API to allow a NF service consumer to convey information to the UDSF on how to categorize each tag in the RecordMeta and accordingly optimize the way records are stored and searched for.

One or more aspects of this disclosure enhance the UDSF API so that timers may be stored in the UDSF and the NF service consumer may be notified upon expiration of the timers or may use an efficient mechanism to poll for expired timers.

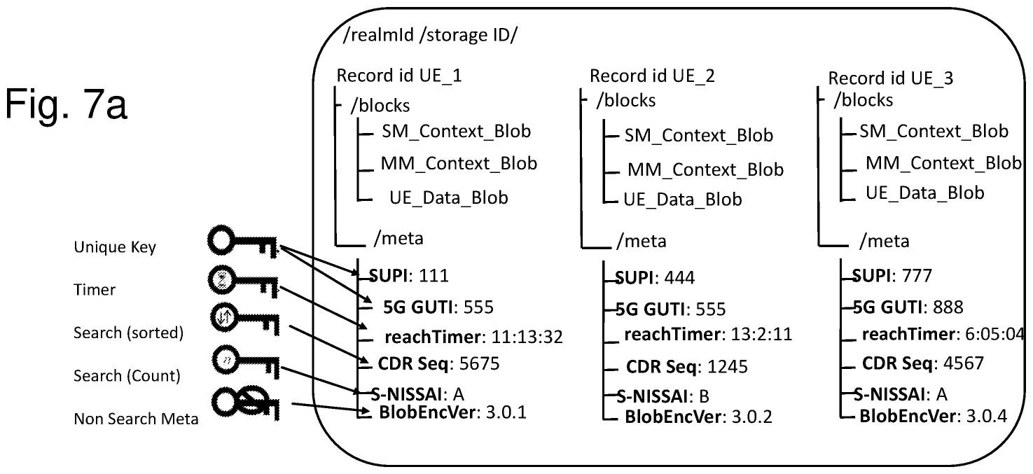

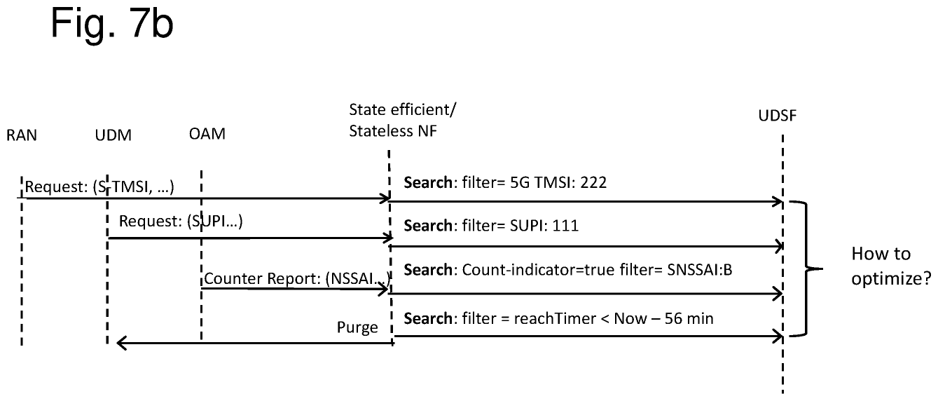

FIG. 7b shows a signalling diagram of a process for searching for records stored in a UDSF.

Here are certain examples where Searches based on RecordMeta tags may need to be performed.

For example, a NF may receive a request from a RAN of a UE identified by its 5G temporary mobile subscriber identifier (5G STMSI). In order to serve the request the NF must retrieve the UE context thus it may send a search query to a UDSF to obtain the record of the UE using the 5G TMSI as the search criterion. The NF may receive the record of the UE from the UDSF and further process the request.

The NF may receive a request from a UDM or a UE identified by its SUPI. In this case the NF may send a search query to the UDSF to obtain the record of the UE using the SUPI as the search criterion. The NF may receive the record of the UE from the UDSF and further process the request.

The NF may receive a request from an OAM to obtain the number of UEs registered to a specific slice (S-NSSAI). The NF may send a search query to the UDSF to obtain the number of records where the given slice is included in the relevant metadata tag and may prepare a report for the OAM.

Another example is when the NF (e.g. AMF) may need to run a background activity to purge stale UEs. In order to complete this operation the NF may periodically need to send a search query to the UDSF to identify and retrieve the records of UEs for which a timer, for example a reachability timer, has expired.

Rel-16 TS.29.598 has defined a metadata structure for records (RecordMeta IE) however the UDSF does not have the information required to optimize searches based on metadata tag filtering.

Indexes and stored procedures are used in other database structures but there is no standardized API to create such constructs in the UDSF.

RecordMeta IEs contain “ttl” IE. However, this is a single timer with a specific usage as it refers to the lifetime of the record (i.e. after the expiration the record is deleted) and cannot be used for generic call processing related purposes.

One or more aspects of the disclosure relate to categorizing the RecordMeta tags based on their use and enhance the UDSF API so that a NF service consumer may convey that categorization to the UDSF in a standardized manner.

One or more aspects of the disclosure relate to implementing timers with stateless NF service consumers that use UDSF for backend storage.

To enable support for timer handling with stateless NFs the following principles are proposed. A NF may store timers in the UDSF. In order to determine and act on expired timers, the NF or NF in a same set of NF may poll the UDSF for expired timers. Alternatively, the UDSF may notify the NF that last updated the context for expired timers.

In order to facilitate efficient search to determine records based on expired timers, it is proposed to introduce a search key based on expired timers.

For optimized search, each tag belonging to the RecordMeta “tags” IE (TS 29.598) may be associated with a key type. The key type may be one of the following key types.

A unique type: The tag may be used for search and may result at most in one matching record. For example, the tag may correspond to a SUPI, subscription concealed identifier (SUCI), a generic public subscription identifier (GPSI), 5G-GUTI, 5G S-TMSI, NG application protocol identifier (NGAP-ID) of a UE or other.

A search type: The tag may be used for search and may result in multiple matching records. For example, the tag may correspond to a NF service consumer set identifier and may be used to determine the UE(s) served by the NF service consumer set or a tracking area code and may be used to determine the UE(s) located in a tracking area.

A sum type: The tag may be used for count search only. For example, the tag may correspond to a S-NSSAI and may be used to determine a number of UEs registered to a specific slice

A search-sum type: The tag may be a combination of the two previous tags and can be used for count searches but also search that may result in multiple matching records. For example, the tag may correspond to a S-NSSAI and may be used to determine a number of UEs registered to a specific slice in order to report a relevant counter but also to acquire all the UEs in that S-NSSAI so as to update their connection status when the slice is removed from the network.

A timer search Type: The tag may correspond to a timer and may be used to search for records, for example to search for record where the timer has expired.

A timer callback type: The tag may correspond to a timer but cannot be used to search for records, for example to search for record where the timer has expired. However, upon expiry of the timer the UDSF sends a notification to a given callback URI.

Non-search type: The tag may not be used to search for records. For example, the tag name and the tag value correspond to a version of an encoded block blob that is meaningful only for the UDSF Service consumer.

Tags of the unique key type and search key type may have a “sort” attribute. That may be used when searches based on comparison operators “GT” “GTE”, “LT”, or “LTE” are expected (i.e. logically ordered entries).

The Enumeration ComparisonOperator IE may be extended with the addition of an “EXP” operator which may be used to search for records based on whether tags of a timer search key type correspond to expired timers. The UDSF may create an index which maps to all the records with tags of a timer search key type relating to expired timers (e.g. current date time>=expire dateTime).

The mapping of a tag name to a key type along with other attributes, such as a format of a tag value, an indication of whether a tag is optional or mandatory, a default value when the tag is optional or a cardinality may be described in a new resource named MetaSchema (i.e. metadata schema). The MetaSchema may be stored in the UDSF and may be referenced by the RecordMeta of a record when the RecordMeta is stored in the UDSF.

Usage of the MetaSchema is optional. In case it is not stored on the UDSF, the existing Rel-16 API may be used by the UDSF for (unoptimized) searches and proprietary timer implementation.

The Nudsf_DataRepository API may be enhanced to support the MetaSchema. The MetaSchema is stored in a new MetaSchema resource in the nudsfNudsf-dr API structure.

When Records intend to refer to a MetaSchema the MetaSchema are first uploaded on the UDSF. The MetaSchema describes the tags in a RecordMeta and their categorization. The MetaSchema does not describe the block(s) content and/or structure.

The UDSF may use the MetaSchema to create indexes, counters, stored procedures, timers or other in order to optimize searches filtered on the tags.

When records are stored in the UDSF along with the blocks, the RecordMeta may include a reference to the relevant MetaSchema.

The MetaSchema is identified by the SchemaId identifier. Search queries include the SchemaId as a new optional query parameter along with the tag name. When included, the search is limited to records which have the given schemaId value stored in their RecordMeta

Tags of the timer search key type and timer callback key type have tag values with a date time format. Search queries with tags of the timer search key type may comprise the “EXP” ComparisonOperator.

Search queries with tags of the non-search key type or timer callback key type may be rejected.

Searches queries based on the “GT” “GTE”, “LT”, and “LTE” ComparisonOperator may be rejected if the tag values are not sorted.

When a tag of the timer callback key type correspond to an expired timer, the UDSF send a notification message to the callback URI provided in the RecordMeta.

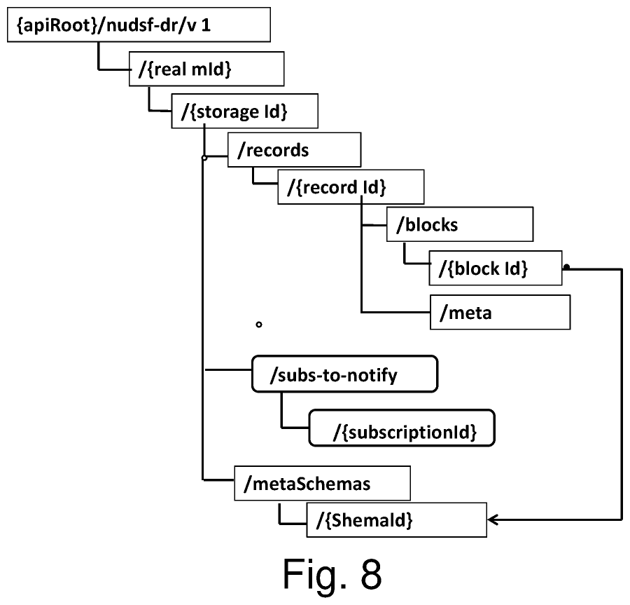

FIG. 8 shows a schematic representation of a resource URI of a nudsf-dr API as per the disclosure. The nudsf-dr API is enhanced to comprise a metaSchema and a RecordMeta referencing the SchemaId of the metaSchema.

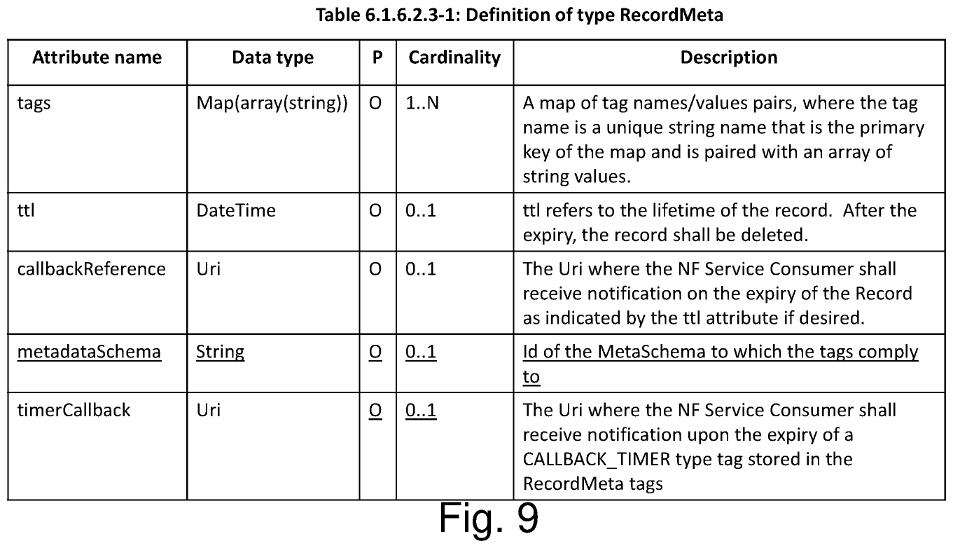

FIG. 9 shows a table providing a definition of a type RecordMeta as per the disclosure. The RecordMeta may comprise a tags attribute, a ttl attribute and a callback reference attribute as per FIG. 6. The RecordMeta may comprise a metachSchema attribute including a reference to the metachSchema (SchemaId) the tags comply with. The RecordMeta may comprise a timer callback attribute. The timer callback attribute may comprise the URI where the NF service consumer receive a notification when a tag of the timer callback key type corresponds to an expired timer.

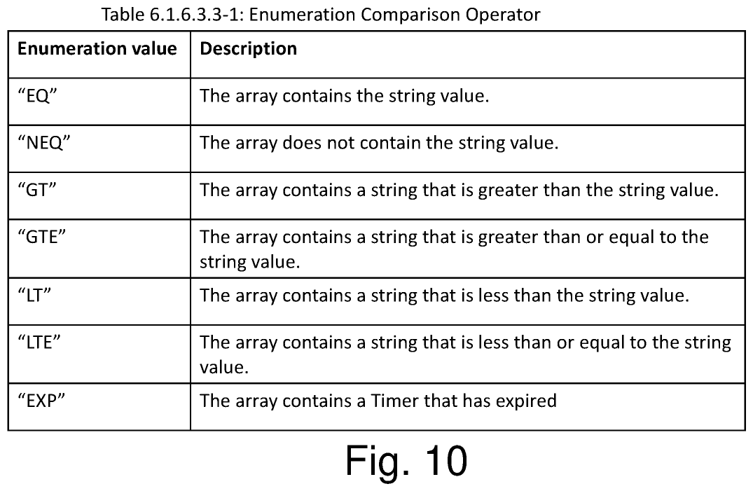

FIG. 10 shows a table providing a list of enumeration comparison operators as per the disclosure. As per TS 29.598 (3GPP Rel-16) the enumeration value may comprise “EQ” (an array contains a string value), “NEQ” (an array does not contain a string value), “GT” (an array contains a string value that is greater than another string value), “GTE” (an array contains a string value that is greater than or equal to another string value), “LT” (an array contains a string value that is less than another string value), “LTE” (an array contains a string value that is less than or equal to another string value) This disclosure introduces the “EXP” (an array contains an expired timer) to the list as an additional value.

A NF service consumer that wants to store a record including a RecordMeta referring to a MetsSchema in order to leverage one or more of the above aspects may first check whether the UDSF already stores the MetaSchema of the RecordMeta included in the record to be stored. If the MetaSchema is not stored in the UDSF the UDSF service consumer first uploads the MetaSchema on the UDSF.

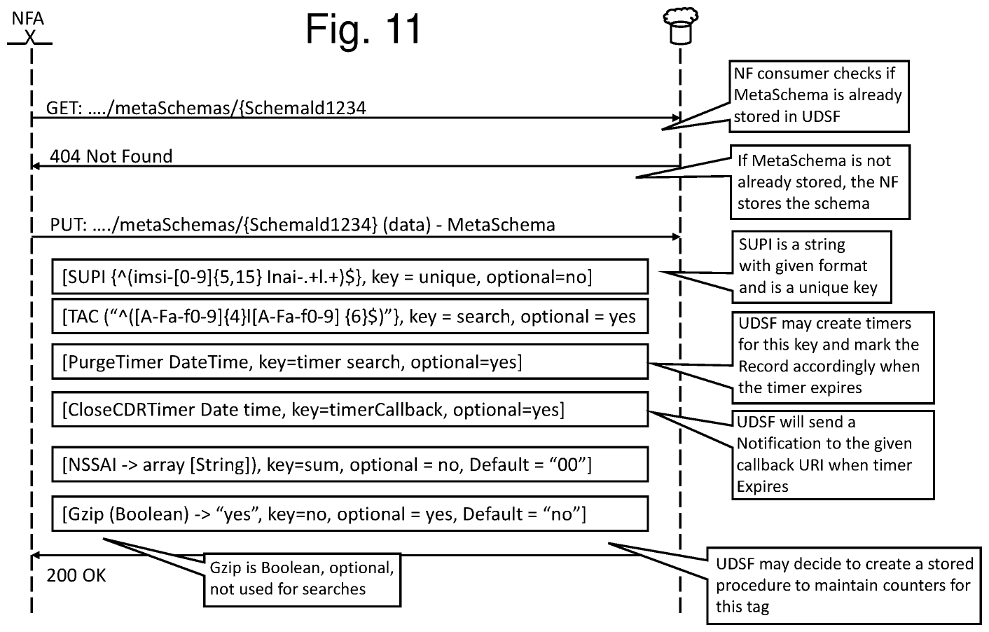

FIG. 11 shows a signalling diagram of a process for storing a MetaSchema in a UDSF as per the disclosure.

The NF service consumer may send a request to the UDSF to determine if the UDSF stores a MetaSchema with a given SchemaId. The NF service consumer may receive an indication from the UDSF that the UDSF does not store the MetaSchema with the SchemaId.

If the MetaSchema is not stored in the UDSF, the NF may send a request to the UDSF to store a MetaSchema which is identified by the SchemaId. The request may comprise the MetaSchema. The MetaSchema may comprise the SchemaId and an array that comprises at least one tag type with at least one attribute. The at least one attribute comprise a tag name, a format of a tag value, an indication of a key type, an indication whether the tag is optional or mandatory, a default value when the tag is optional, a cardinality minimum, a cardinality maximum, a sort indication or other.

In an example, the MetaSchema may comprise a tag type indicating that a RecordMeta comprises a tag corresponding to a SUPI comprising a tag name “SUPI”, a tag value with a format “string” and a key type “unique type”.

In an example, the MetaSchema may comprise a tag type indicating that a RecordMeta may comprise a tag corresponding to a timer comprising a tag name “PurgeTimer”, a tag value with a format “DateTime” and a key type “timer search type”. The UDSF may mark the record associated with the RecordMeta as expired when the timer expires.

In an example, the MetaSchema may comprise a tag type indicating that a RecordMeta may comprise a tag corresponding to a timer comprising a tag name “CloseCDRTimer”, a tag value with a format “DateTime” and a key type “timer Callback type” indicating that the UDSF sends a notification to the given callback URI when the timer expires.

In an example, the MetaSchema may comprise a tag type indicating that a RecordMeta may comprise a tag corresponding to an internal NF service consumer version of an encoded block blob comprising a tag name “Gzip”, a tag value with a format “Boolean”, a key type “non-search type” and a default tag value “no”. The UDSF may not use the tag for searches.

After the MetaSchema has been uploaded to the UDSF, the NF can start storing records 30 including a reference to the MetaSchema the RecordMeta abides by. In case the RecordMeta does not abide by the MetaSchema or the MetaSchema is unknown to the UDSF, the UDSF responds with an appropriate error message.

The NF service consumer may discover whether the UDSF can support the functionality described above via the supported features negotiation mechanism as specified in subclause 6.6.2 of 3GPP TS 29.500 (functionality will be defined as a new Feature (e.g. “MetaSchema) in 29.598).

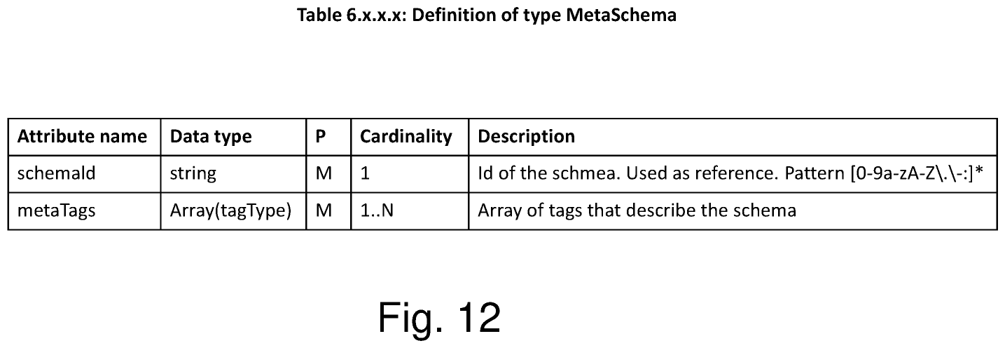

FIG. 12 shows a table providing a definition of a type MetaSchema as per the disclosure. The MetaSchema may comprise a schemaId attribute and a MetaTags attribute. The schemaId attribute is a string identifying the MetaSchema. The MetaTags attribute is an array of tagTypes describing a schema of the RecordMeta.

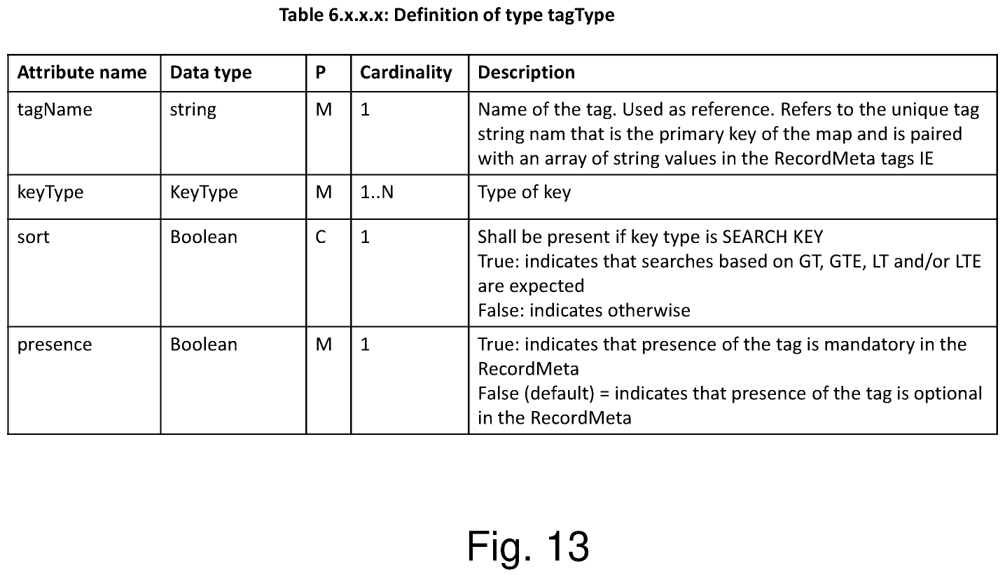

FIG. 13 shows a table providing a definition of a type tagType as per the disclosure. The tagType may comprise a tag name attribute, a key type attribute, a sort attribute, a presence attribute, a cardinality min attribute, a cardinality max attribute, a default attribute or other attributes.

The TagName attribute may be a unique key tag name used in the tag name/values pairs in a RecordMeta tags attribute.

The key type attribute may be a string describing a key type among the unique key type, the search key type, the sum key type, the search sum key type, the timer search key type, the callback timer key type and the non-search key type.

The sort attribute may be a Boolean relevant for key types unique key type and search key type.

The presence attribute may be a Boolean where True indicates that a tag is mandatory and False indicates that a tag is optional.

The cardinality min attribute may be a positive integer.

The cardinality max attribute may be a positive integer greater than the cardinality min.

The default value may be an object. The default value may be mandatory when the presence is optional.

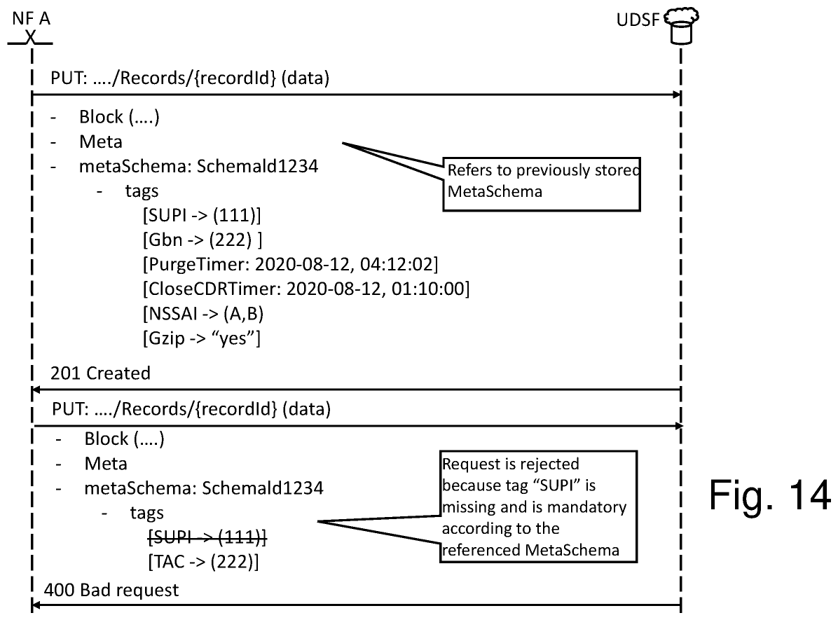

FIG. 14 shows a signalling diagram of a process for storing RecordMeta in a UDSF as per the disclosure.

A NF A may send a request to store a record to the UDSF including a block and RecordMeta with tags complying with the MetaSchema identified by the SchemaId. The UDSF sends a response indicating that the record was stored.

The NF A may send another request to store a record including a block and RecordMeta. with tags not complying with the MetaSchema identified by the SchemaId (e.g. a tag that is mandatory is missing). In that case the UDSF does not store the record but sends a response with an appropriate Error code indicating that the UDSF did not store the record.

Once the records are stored, searches can be efficiently retrieved as UDSF has internally organized the data accordingly.

Searches on tags that are not supported by the defined tag type in the MetaSchema are rejected by the UDSF.

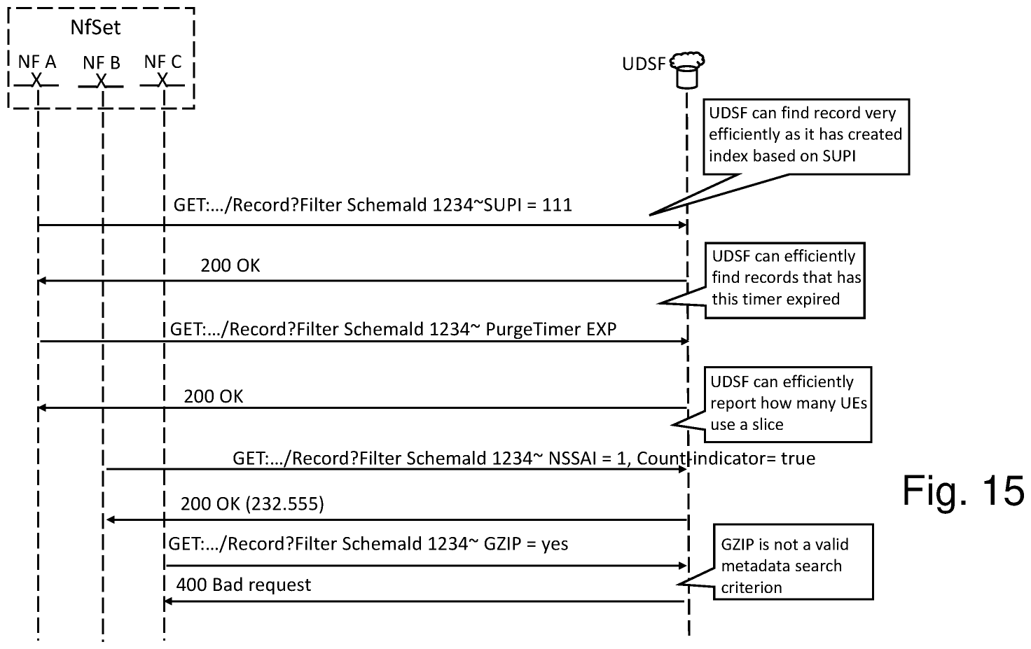

FIG. 15 shows a signalling diagram examples of a UDSF consumer using RecordMeta tags to efficiently search for stored records as per the disclosure.

NF A, B and C may be part of a set of NFs.

The NF A may send a search query comprising a SchemaId (e.g. 1234), a tag name (e.g. SUPI) and a tag value. The UDSF may have created an index based on the tag name and therefore may retrieve a matching record efficiently. The NF service consumer A accordingly receives the matching record from the UDSF.

The NF A may send a search query comprising a SchemaId (e.g. 1234), a tag name (e.g. PurgeTimer) and a comparison operator (EXP). The UDSF may identify one or more matching records where a tag value associated with the tag name has expired. The NF service consumer B receives the one or more matching records from the UDSF.

The NF B may send a search query comprising a SchemaId (e.g. 1234), a tag name (e.g. NSSAI) and a tag value. The UDSF may identify a number of one or more matching records where a tag value associated with the tag name is equal to the tag value in the request. The NF B may receive the number of the one or more matching records from the UDSF.

The NF may send a search query comprising a SchemaId (e.g. 1234), a tag name (e.g. GZIP) and a tag value (yes). The UDSF may reject the search query. The NF service consumer C may not receive any matching records from the UDSF.

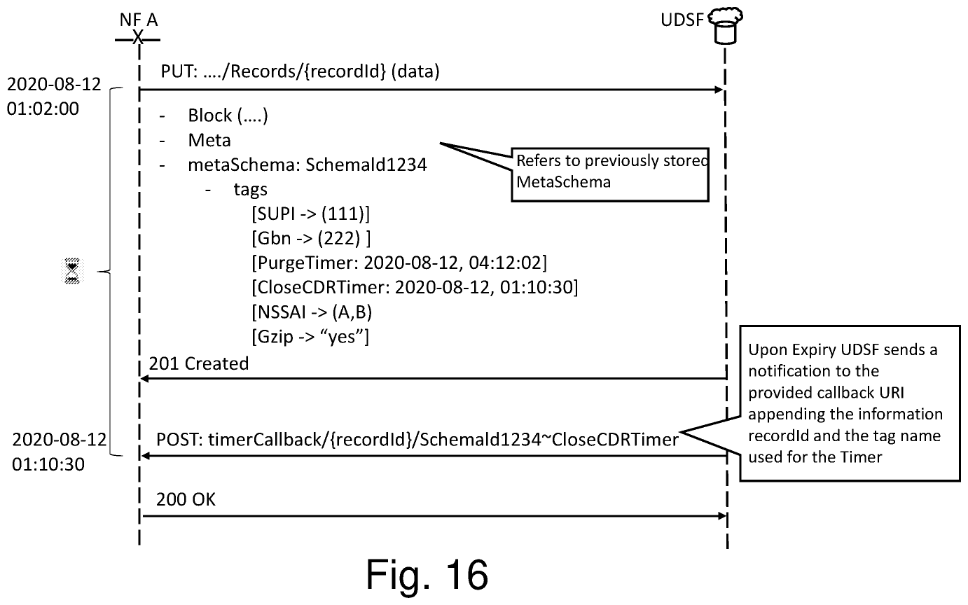

FIG. 16 shows a signalling diagram of a process for using RecordMeta in a UDSF to notify an expired timer as per the disclosure.

A NF A may send a request to store a record to the UDSF with a block and RecordMeta. with tags complying with tagTypes of the MetaSchema identified by the SchemaId. One of the tags may be of the callback timer type. This tag may have a tag name (e.g. CloseCDRTimer) a tag value (e.g. 2020-08-12 01:10:30) and a callback URI. The UDSF stores the record and sends an appropriate success response.

Upon expiry of the callback timer as indicated by its tag value (2020-08-12 01:10:30), the UDSF sends a notification to the given callback URI.

The NF may be able to also update the MetaSchema.

Backwards compatible changes to the MetaSchema may be applied even when records referencing the MetaSchema exist in the UDSF. Example of Backwards compatible changes to a MetaSchema is adding an optional tag with default value or increasing the max cardinality of a tag. In such a case the NF may update the MetaSchema (e.g. via PUT/PATCH commands) without having to first migrate the RecordMeta of the records.

Backwards incompatible changes to the MetaSchema may not be applied when records referencing to that MetaSchema exist in the UDSF. In that case the NF service consumer is responsible to migrate and/or convert the RecordMeta.

A possible migration procedure may be as follows.

The NF service consumer may store a new MetaSchema with a new MetaSchema name or new SchemaId to the UDSF. The old MetaSchema is not yet deleted or updated.

Whenever the NF service consumer stores a new record or updates an existing record to the UDSF the NF that complies to the new RecordMeta format and uses the new MetaSchema as reference.

For the period until all Records are migrated to the new MetaSchema the UDSF consumers must perform search with both the old Metaschema and new Metaschema. When all records are migrated to the new MetaSchema, searches may be performed with only the new MetaSchema and the old MetaSchema can be deleted.

One or more aspects of the disclosure optimize searches by enabling the UDSF to decide when indexes, timers or stored procedures should be used for a RecordMeta tags (efficiency).

One or more aspects of the disclosure optimize organization of RecordMeta tags and reduce search response time (improved latency)

One or more aspects of the disclosure standardize the MetaSchema definition API and allows multivendor UDSF/NF service consumer deployments (interoperability) One or more aspects of the disclosure organize the data within the UDSF considering also the MetaSchema and search criteria.

One or more aspects of the disclosure provide an interoperable solution for the timer which may be essential for a stateless/state-efficient NF.

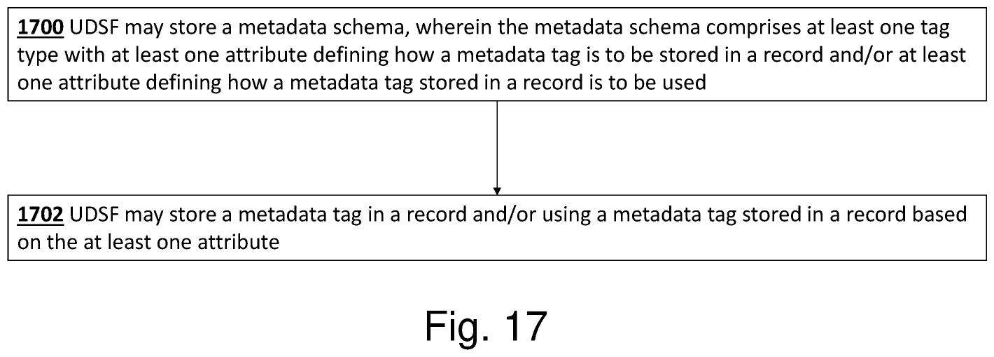

FIG. 17 shows a block diagram of a method performed by a UDSF for storing metadata (RecordMeta) in a record and/or using metadata (RecordMeta) stored in a record as per the disclosure.

In step 1700 a UDSF may store a metadata schema, wherein the metadata schema (e.g. MetaSchema) comprises at least one tag type with at least one attribute defining how a metadata (e,g. RecordMeta) tag is to be stored in a record and/or at least one attribute defining how a metadata tag stored in a record is to be used.

In step 1702 the UDSF may store a metadata tag in a record and/or using a metadata tag stored in a record based on the at least one attribute.

The at least one attribute defining how a metadata tag is to be stored in a record may comprise a tag name.

The at least one attribute defining how a metadata tag is to be stored in a record may comprise a format of a tag value.

The at least one attribute defining how a metadata tag is to be stored in a record may comprise an indication of whether a presence of the metadata tag is optional or mandatory.

The at least one attribute defining how a metadata tag is to be stored in a record may comprise an indication of a default tag value when the presence of the metadata tag is optional.

The at least one attribute defining how a metadata tag stored in a record is to be used comprises a key type. The key type may be one of: a first key type defining that the metadata tag can be used to search for the record and the search results in at most one matching record; a second key type defining that the metadata tag can be used to search for the record and the search results in one or more matching records; a third key type defining that the metadata tag can be used to search for the record and the search results in a sum of one or more matching records; a fourth key type defining that the metadata tag can be used to search for the record and the search results in one or more matching records and defining that the metadata tag can be used to search for the record and the search results in a sum of one or more matching records; a fifth key type defining that the metadata tag correspond to a timer, can be used to search for the record and the search results in one or more matching records; a sixth key type defining that the metadata tag correspond to a timer and cannot be used to search for the record; and a seventh key type defining that the metadata tag cannot be used to search for the record.

The metadata tag may correspond to a timer, comprises a timer name, a timer value and a uniform resource identifier where a network function receives a notification when the timer value expires.

The metadata schema may comprise a metadata schema identifier.

The UDSF may receive the metadata schema identifier with the metadata schema from a NF. The UDSF may store the metadata schema identifier with the metadata schema.

The UDSF may receive a metadata tag with the metadata schema identifier from a NF. The UDSF may determine that the metadata tag abides by the at least one attribute of the at least one tag type of the metadata schema. The UDSF may store the metadata tag.

The UDSF may receive a search query with the metadata schema identifier from a network function. The UDSF may use the metadata schema identifier to search for a record.

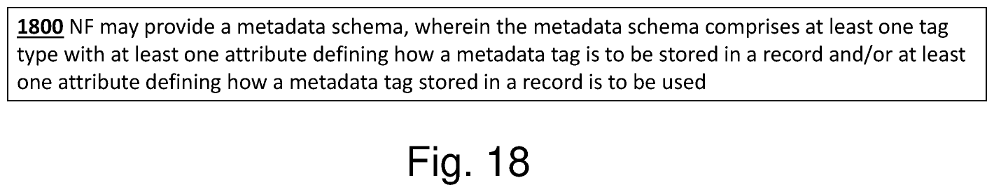

FIG. 18 shows a block diagram of a method performed by a NF service consumer for storing metadata (RecordMeta) in a record and/or using metadata (RecordMeta) stored in a record as per the disclosure.

In step 1800 a NF may provide a metadata schema, wherein the metadata schema comprises at least one tag type with at least one attribute defining how a metadata tag is to be stored in a record and/or at least one attribute defining how a metadata tag stored in a record is to be used.

The at least one attribute defining how a metadata tag is to be stored in a record may comprise a tag name.

The at least one attribute defining how a metadata tag is to be stored in a record may comprise a format of a tag value.

The at least one attribute defining how a metadata tag is to be stored in a record may comprise an indication of whether a presence of the metadata tag is optional or mandatory.

The at least one attribute defining how a metadata tag is to be stored in a record may comprise a default tag value when the presence of the metadata tag is optional.

The at least one attribute defining how a metadata tag stored in a record is to be used may comprise at least one key type. The key type may be one of: a first key type defining that the metadata tag can be used to search for the record and the search results in at most one matching record; a second key type defining that the metadata tag can be used to search for the record and the search results in one or more matching records; a third key type defining that the metadata tag can be used to search for the record and the search results in a sum of one or more matching records; a fourth key type defining that the metadata tag can be used to search for the record and the search results in one or more matching records and defining that the metadata tag can be used to search for the record and the search results in a sum of one or more matching records; a fifth key type defining that the metadata tag correspond to a timer, can be used to search for the record and the search results in one or more matching records; a sixth key type defining that the metadata tag correspond to a timer and cannot be used to search for the record; and a seventh key type defining that the metadata tag cannot be used to search for the record.

The metadata tag may correspond to a timer, may comprise a timer name, a timer value and a uniform resource identifier. The NF may receive a notification when the timer value expires via the uniform resource identifier.

The metadata schema may comprise a metadata schema identifier.

The NF may provide the metadata schema identifier with the metadata schema to a UDSF.

The NF may provide the metadata with the metadata schema identifier to the UDSF.

The NF may provide a search query with a metadata schema identifier to the UDSF.

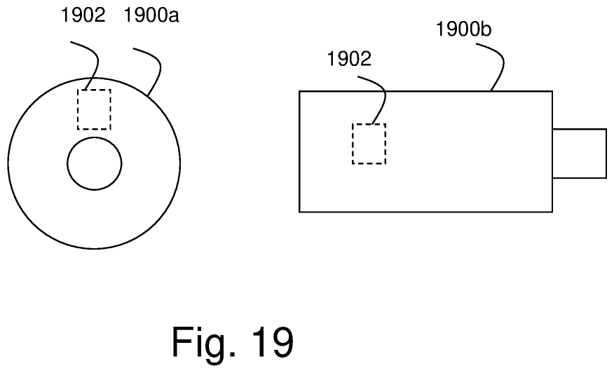

FIG. 19 shows a schematic representation of non-volatile memory media 1900a (e.g. computer disc (CD) or digital versatile disc (DVD)) and 1900b (e.g. universal serial bus (USB) memory stick) storing instructions and/or parameters 1902 which when executed by a processor allow the processor to perform one or more of the steps of the methods of FIGS. 17 and 18.

It is noted that while the above describes example embodiments, there are several variations and modifications which may be made to the disclosed solution without departing from the scope of the present invention.

It will be understood that although the above concepts have been discussed in the context of a 5GS, one or more of these concepts may be applied to other cellular systems.

It will also be understood that although the above mechanism has been described as being implemented by a messaging framework, the mechanism may be implemented by another apparatus, entity or function.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIGS. 17 and 18, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Alternatively or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1. An apparatus comprising at least one processor and at least one memory including computer code for one or more programs, the at least one memory and the computer code configured, with the at least one processor, to cause the apparatus at least to:
store a metadata schema, wherein the metadata schema comprises at least one tag type with at least one attribute defining how a metadata tag is to be stored in a record and/or at least one attribute defining how a metadata tag stored in a record is to be used; and
store a metadata tag in a record and/or use a metadata tag stored in a record based on the at least one attribute.

2. The apparatus of claim 1, wherein the at least one attribute defining how a metadata tag is to be stored in a record comprises a tag name.

3. The apparatus of claim 2, wherein the at least one attribute defining how a metadata tag is to be stored in a record comprises a format of a tag value.

4. The apparatus of claim 1, wherein the at least one attribute defining how a metadata tag is to be stored in a record comprises an indication of whether a presence of the metadata tag is optional or mandatory.

5. The apparatus of claim 4, wherein the at least one attribute defining how a metadata tag is to be stored in a record comprises an indication of a default tag value when the presence of the metadata tag is optional.

6. The apparatus of claim 2, wherein the at least one attribute defining how a metadata tag stored in a record is to be used comprises a key type.

7. The apparatus of claim 6, wherein the key type is one of:
a first key type defining that the metadata tag can be used to search for the record and the search results in at most one matching record;
a second key type defining that the metadata tag can be used to search for the record and the search results in one or more matching records;
a third key type defining that the metadata tag can be used to search for the record and the search results in a sum of one or more matching records;
a fourth key type defining that the metadata tag can be used to search for the record and the search results in one or more matching records and defining that the metadata tag can be used to search for the record and the search results in a sum of one or more matching records;
a fifth key type defining that the metadata tag correspond to a timer, can be used to search for the record and the search results in one or more matching records;
a sixth key type defining that the metadata tag correspond to a timer and cannot be used to search for the record; and
a seventh key type defining that the metadata tag cannot be used to search for the record.

8. The apparatus of claim 1, wherein the metadata tag corresponds to a timer, comprises a timer name, a timer value and a uniform resource identifier where a network function receives a notification when the timer value expires.

9. The apparatus of claim 1, wherein the metadata schema comprises a metadata schema identifier.

10. The apparatus of claim 9, wherein the at least one memory and the computer code are further configured, with the at least one processor, to cause the apparatus to:
receive the metadata schema identifier with the metadata schema from a network function; and
store the metadata schema identifier with the metadata schema.

11. The apparatus of claim 9, wherein the at least one memory and the computer code are further configured, with the at least one processor, to cause the apparatus to:
receive a metadata tag with the metadata schema identifier from a network function;
determine that the metadata tag abides by the at least one attribute of the at least one tag type of the metadata schema; and
store the metadata tag.

12. The apparatus of claim 9, wherein the at least one memory and the computer code are further configured, with the at least one processor, to cause the apparatus to:
receive a search query with the metadata schema identifier from a network function; and
use the metadata schema identifier to search for a record.

13. The apparatus of claim 1, wherein the apparatus is an unstructured data storage function.

14. An apparatus comprising at least one processor and at least one memory including computer code for one or more programs, the at least one memory and the computer code configured, with the at least one processor, to cause the apparatus at least to:
provide a metadata schema, wherein the metadata schema comprises at least one tag type with at least one attribute defining how a metadata tag is to be stored in a record and/or at least one attribute defining how a metadata tag stored in a record is to be used, and wherein the metadata schema further comprises a metadata schema identifier.

15. (canceled)

16. The apparatus of claim 15, wherein the at least one memory and the computer code are further configured, with the at least one processor, to cause the apparatus to:
provide the metadata schema identifier with the metadata schema to an unstructured data storage function.

17. The apparatus of claim 15, wherein the at least one memory and the computer code are further configured, with the at least one processor, to cause the apparatus to:
provide the metadata with the metadata schema identifier to an unstructured data storage function.

18. The apparatus of claim 14, wherein the apparatus is a network function.

19. A method comprising:
storing a metadata schema, wherein the metadata schema comprises at least one tag type with at least one attribute defining how a metadata tag is to be stored in a record and/or at least one attribute defining how a metadata tag stored in a record is to be used; and
storing a metadata tag in a record and/or using a metadata tag stored in a record based on the at least one attribute.

20. A method comprising:
providing a metadata schema, wherein the metadata schema comprises at least one tag type with at least one attribute defining how a metadata tag is to be stored in a record and/or at least one attribute defining how a metadata tag stored in a record is to be used, and wherein the metadata schema further comprises a metadata schema identifier.

21. (canceled)

22. A method of claim 20, further comprising:
providing the metadata schema identifier with the metadata schema to an unstructured data storage function.
